(19) United States
(12) Patent Application Publication
(10) Pub. No.: US 2003/0161472 A1
(43) Pub. Date: Aug. 28, 2003

(54) Server-assisted public-key cryptographic method

(76) Inventors: Chi Hung Tong, Hong Kong (CN); Chi Kwong Hui, Hong Kong (CN); Ada Wai Chee Fu, Hong Kong (CN); Francis Chi Moon Lau, Hong Kong (CN)

Correspondence Address: PENNIE AND EDMONDS, 1155 AVENUE OF THE AMERICAS, NEW YORK, NY, 100362711

(21) Appl. No.: 10/087,010

(22) Filed: Feb. 27, 2002

(51) Int. Cl. H04L 9/00

(52) U.S. Cl. 380/270; 713/153

(57) ABSTRACT

A server-assisted computational method for computing the RSA cryptography is delineated in this document. The method enables public-key functions on the resource-constrained devices, such as a mobile phone or a PDA, by leveraging the rich computing resources provided by the server-grade computers on the network. Public-key processing, which is computationally intensive as commonly known, if loaded solely on the constrained device, would easily overwhelm the processor capacity and electrical power supply. The server-assisted method enables such device to drive a powerful server computer on the Internet to carry out the public-key number-crunching job for its sake. Some near-completion results are communicated back to the device. From that, the final public-key cryptograph is derived. Privacy and security are the utmost important considerations in public-key systems. The present invention ensures the privacy of the device by blinding the server of the secret message and the crypto keys of the device. The merit is that the client device is able to accomplish the public-key processing with the help of the server, but without compromising the private crypto keys and confidential message code to the server.

### FIELD OF THE INVENTION

The present invention relates to a server-assisted computational method for the RSA processing that is viable on the resource-constrained devices. The invention is relevant to the fields of client-server distributed computing and public-key cryptography.

### BACKGROUND OF THE INVENTION

Public-key cryptography is proven effective as a mechanism for secure messaging in an open network where no intermediate routers are presumed trustworthy to the end-communicators. The RSA algorithm nowadays represents the most widely adopted public-key cryptographic algorithm.

The RSA core comprises of encoding and decoding modules that are primarily exponentiation engines. Suppose (e, n) constitutes the encoding key, the encryption process is an exponentiation of the message M being raised to the power e under the modulus n to give the cryptograph S. If (d, n) is the decoding key, the decryption is the process that raise S to the power d under the modulus n to recover the original message M.

The RSA technique exploits the un-surmountable complexity of discrete factorization to deter any attempts of cracking the key pair (e, d). The technique is thus safe for cryptographic purposes. Contemporarily, it forms the underpinning of many public-key infrastructure systems for e-business activities on the Internet.

As e-business is rapidly expanding to the users of wireless handhelds, such as mobile phones, a secure transaction protocol that is effective on the wireless domain is the most desired technology to the e-business practitioners in order for them to seamlessly extend the secure transaction activities from the wire-lined Internet to the wireless counterpart.

Nevertheless, the solution is not straightforward. Public-key cryptography is so much resource demanding that the technology has never been feasible on the resource-deprived computing devices, such as mobile handheld. Interim solutions have been proposed which effect via reduction in security functionality or certificate fields in order to fit with the CPU limitation. The public-key infrastructure that prevails in the wire-lined world thus takes a reduced form, weaker functionality and security strength, when ported to the wireless domain.

WTLS has been proposed as such a streamlined form of the commonly employed SSL security protocol for the wireless world. A concern, however, is the incompatibility between the SSL and WTLS domains, resulting in a vulnerable gap at the wireless gateway and failing the most desired end-to-end secure message tunneling (FIG. 1).

Prior art handles a similar problem of conducting the RSA crypto processing on an IC card with load sharing between the IC card and the host computer in a point-of-sales setup. In those methods, the encoding or decoding key that represents the secret parameter held inside the IC card is broken into bit blocks, e₀, e₁, e₂, . . . eₗ.

e=e₀+e₁·2^{k}+e₂·2^{2k}+ . . . +e₁·2^{1k}

M^{e}=(M)^{e}^{₀}·(M²^{^{k}})^{e}^{₁}·(M²^{^{2k}})^{e}^{₂} . . . (M²^{^{1k}})^{e}^{₁} mod n

The load sharing is done in the way that the host computer conducts the exponentiation for the base values of individual blocks (powers of 2^{k}, 2^{2k}, . . . 2^{1k} on M) whereas the IC card carries out the intra-block exponentiations (powers of e₀, e₁, e₂, . . . , e₁) to obtain the final cryptograph M^{e}.

As the result, the secret key is well kept by withholding it in the IC card. The load sharing is effective. Nevertheless, the comment is that the computational requirement on the IC card is still significant.

The present invention employs a more powerful secrecy model and offloads more of the computational requirements to the server side. As a result, the processor-heavy RSA becomes practically possible on a resource-poor handheld device.

When the mobile handheld can act with the regular cryptographic capability, the need for a reduced security protocol, such as WTLS, is immaterial. Consequently, the mobile handheld can work in full compatibility with the existing Internet SSL protocol, and the end-to-end secure tunneling is possible (FIG. 2).

### SUMMARY OF THE INVENTION

The present invention is a client-server computing method to enable a resource-deprived device to accomplish the otherwise overwhelming public-key processing. It is made possible by shifting the load of computation to the powerful server computer on the Internet. The result is that the client device drives the resource-rich server computer to carry out the bulk of the computation for its sake. The merit is that the server during the process is totally blinded of the secret parameters (the message code and the crypto key) of the client.

The core of the RSA runtime is the exponentiation operation. During the encryption phase, a message code is numerically raised to the exponential power as specified by the encryption key. Upon decryption, the original message is recovered by another exponentiation using the decryption key on the cryptograph. The technique although computationally expensive, is mostly affordable to the Internet computers nowadays.

The present invention enables the handheld to leverage the computing power of the Internet server computer to bear the load of the exponentiation computation so that the public-key cryptography becomes possible on the handheld in a logical sense.

Our method employs a more powerful secrecy model in which the key is transformed and masked by a bunch of random numbers. Rather than withholding the long RSA key (1024 bits), the client can keep a portion of the data (128 bits) that correspond to the equivalent search space (2¹²⁸). With that, the load sharing can be attained much more effectively between the client and the server by offloading most of the exponentiation computation to the server side.

The present invention may be understood more fully by reference to the following detailed description and illustrative examples which are intended to exemplify non-limiting embodiments of the invention.

The first embodiment is a client-server scheme for the exponentiation operation.

The second embodiment extends on the robustness of the method. Intermediate results from the server side are cross-validated against one another to discover and thus decline any sabotage attacks from the server side in the case that the server is compromised.

### BRIEF DESCRIPTION OF DRAWINGS

FIG. 1 illustrates the security weakspot at the wireless gateway.

FIG. 2 shows the client-driven server-assisted strategy for the public-key cryptography.

FIG. 3 is the flowchart showing the first embodiment of the present invention.

FIG. 4 is the flowchart showing the second embodiment of the present invention.

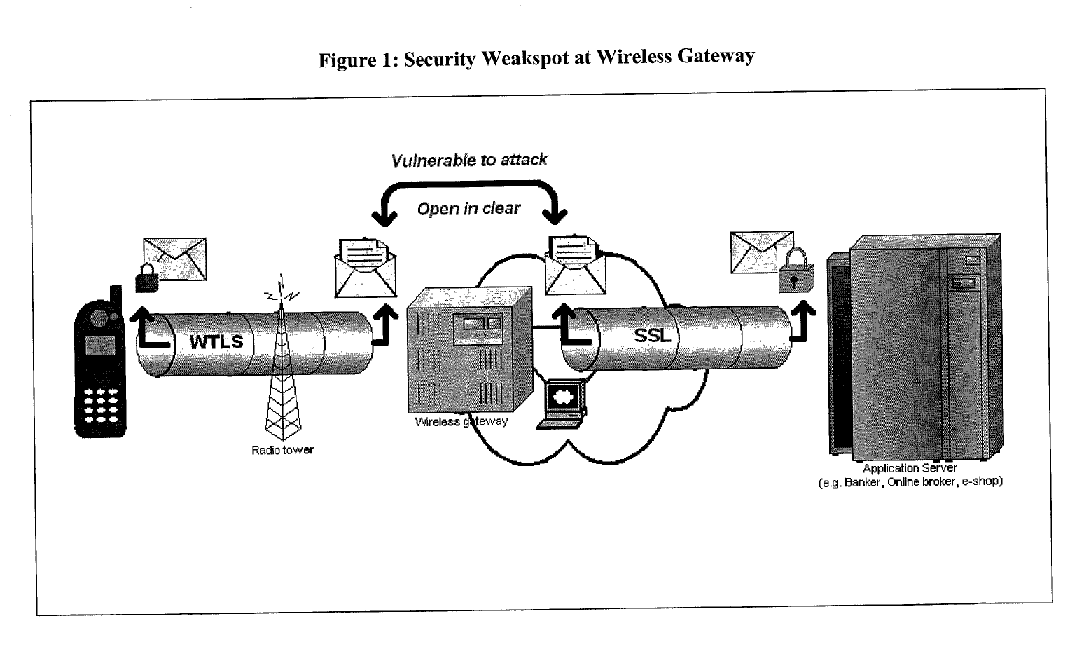

### DETAILED DESCRIPTION AND PREFERRED EMBODIMENT

The present invention will be more readily understood by referring to the following examples and preferred embodiments, which are given to illustrate the invention rather than limit its scope.

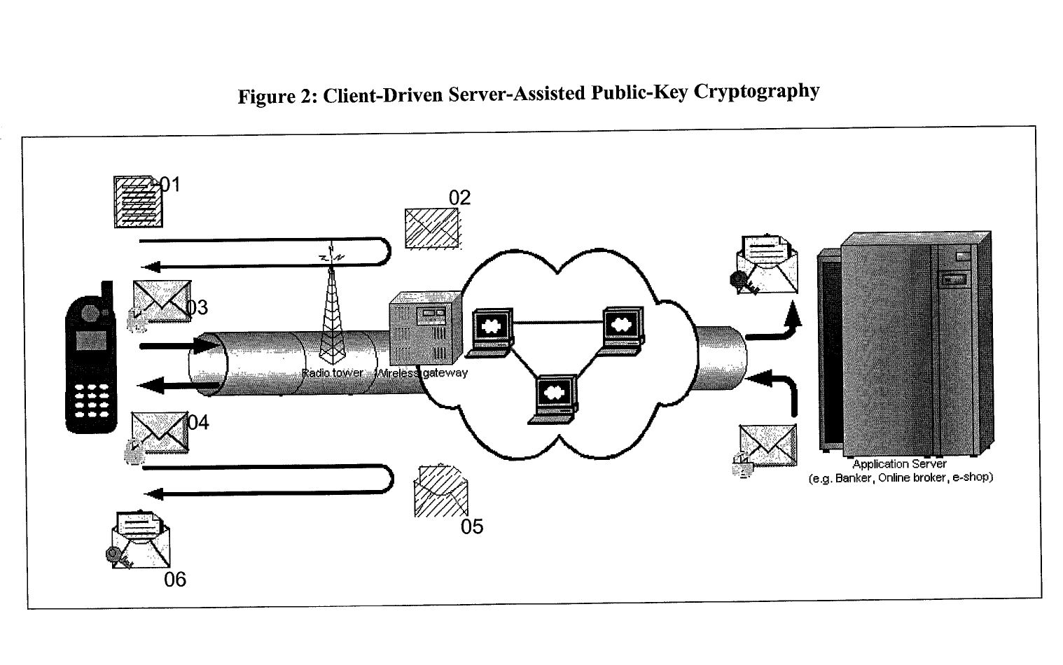

The present invention embodies two versions of design. The core of the RSA public-key cryptographic processing involves the computation of exponentiation operations. As the handheld device is incapable of carrying out the demanding processing, it ships the data and crypto parameters to the server computer and makes the server compute the exponentiations for it. The handheld, as the client in this relationship, ensures the privacy of his secret data and parameters by scrambling all the data he sends out to the server (FIG. 2/01).

The server is totally blinded of the client's secrets. It takes the role of an exponentiation engine, producing the near-completion result for the cryptographic process (FIG. 2/02). Upon returning of the exponentiation result, the handheld finishes off the entire computation with its unshared secrets to churn out the final cryptograph (FIG. 2/03) for that cryptographic process. When communicating with the cryptograph, the handheld is guaranteed end-to-end security as no third party has the key to reveal the original message code.

In the similar process, the end-to-end security is achieved during the deciphering phase as well. A private message is sent to the handheld (FIG. 2/04). The handheld as the client drives the server computer to carry out the exponentiation processing to arrive at a near-completed decryption result (FIG. 2/05). Upon receiving the result, the handheld completes the decryption process with its unshared secrets (FIG. 2/06). Consequently, the most desired end-to-end communication model is secured.

In the following sections, the mathematical formulation and the communication protocols of the two embodiments are detailed.

### EMBODIMENT 1

The first embodiment reformulates the RSA algorithm as a client-server computational scheme. In the scheme, the secret hiding for the message code and the client's crypto key is well considered.

As the formulation of the RSA algorithm is symmetric for both encryption and decryption, we simplify the discussion by posting the encryption case only. The resulting client-server scheme is also applicable for decryption case without modification.

A. Client-server Model for Exponentiation

The goal is to shift to the server computer the load of calculating the cryptograph S from the message M and the crypto key e.

S=M^{e} mod n (1)

The exponent e is broken into components eᵢ, i=1 , . . . , k.

e=e₁(r₁₂−r₁₁)+ . . . +eₖ(rₖ₂−rₖ₁)

S=M^{e}=M^{e}^{₁}^{(r}^{₁₂}^{-r}^{₁₁}⁾ . . . M^{e}^{ₖ}^{(r}^{ₖ₂}^{-r}^{ₖ₁}⁾ (2)

The rᵢⱼ terms in (2) are integers of small-values. To hide M and e from the server, the client scrambles M and the e-components with random numbers. For n=p·q, we have φ=(p−1)·(q−1). Then

\tilde{M}=(a·M) mod n (3)

eᵢ₁=(eᵢ+uᵢ·rᵢ₁) mod φ

eᵢ₂=−(eᵢ+uᵢ·rᵢ₂) mod φ; i=1, . . . , k (4)

Define partial terms zᵢⱼ=\tilde{M}^{e}^{ᵢⱼ} mod n. Expand with (3) and (4),

zᵢ₁=(a·M)^{e}^{ᵢ}^{+u}^{ᵢ}^{·r}^{ᵢ₁} mod n

zᵢ₂=(a·M)^{-(e}^{ᵢ}^{+u}ᵢ^{·r}^{ᵢ₂₎} mod n (5)

Solve (5) for M^{e}^{ᵢ}^{(r}^{ᵢ₂}^{-r}^{ᵢ₁₎},

$${M}^{{e}_{i} ( {r}_{i2} - {r}_{i1} )} = ( {a}^{{e}_{i} ( {r}_{i1} - {r}_{i2} )} \cdot ( {z}_{i1}^{{r}_{i2}} \cdot {z}_{i2}^{{r}_{i1}} ) ) mod n \qquad ( 6 )$$

Now, the last step follows the expression (2) and puts the k components as calculated in (6) together to derive the cryptograph S.

$$S = {M}^{e} = ( A \cdot {\prod }_{i = 1}^{k} ( {z}_{i1}^{{r}_{i2}} \cdot {z}_{i2}^{{r}_{i1}} ) ) mod n \\ where {a}^{e} \cdot A ≡ 1 ( mod n ) \qquad ( 7 )$$

B. The Client-server Protocol

In a preprocessing phase, the client generates and stores in its memory the random numbers a, A. The job can be done by the client during its idle time or pre-computed by another computer and downloaded to the client in a secure channel. The actual implementation is flexible for this step.

During the runtime, the client generates the random decomposition of e as in (2,4), and scrambles the message M as in (3). The client then ships the data to the server where the partial terms zᵢⱼ's are computed (as in (5)). Upon receiving the partial terms in return, the client computes (7) to obtain the cryptograph.

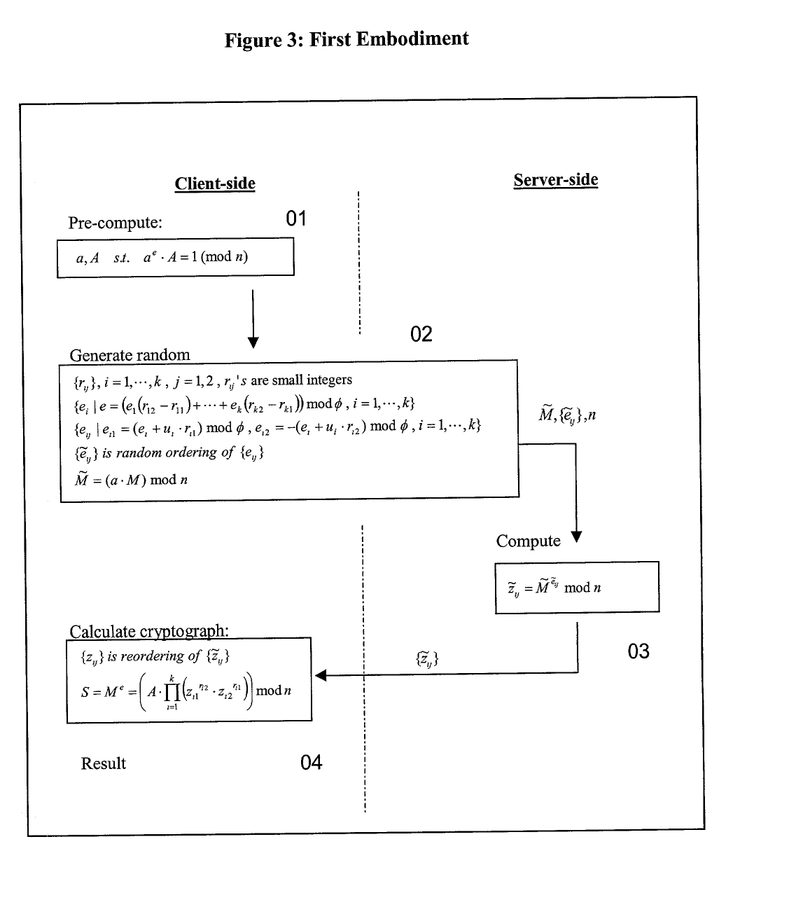

Referring to FIG. 3, the client-server protocol is carried out in four steps:

1) Pre-processing (FIG. 3/01)

The random number a and its reciprocal A are generated as the parameters for scrambling the message code (in (3)) before sending it to the server, and for de-scrambling for the final cryptograph after the partial terms have been returned from the server (in (7)).

2) Client Generates Random Numbers (FIG. 3/02)

The client generates a random decomposition of the crypto key e into a set of eᵢⱼ components. It is intended to ask the server to compute the partial terms of M^{e}^{ᵢⱼ}.

In order to hide the information from the server, the message code is scrambled with a to give \tilde{M}, and the eᵢⱼ set is randomly re-ordered to give {\tilde{e}ᵢⱼ}.

With such scrambling and random-ordering, the server should have no easy way to guess out how the client derives the final cryptograph at the end.

The data \tilde{M}, {\tilde{e}ᵢⱼ} are then communicated to the server for the exponentiation computation.

3) Server Computes Exponentiations (FIG. 3/03)

Upon receiving the scrambled data \tilde{M}, {\tilde{e}ᵢⱼ} from the client, the server calculates the exponentiation terms \tilde{z}ᵢⱼ as in (5).

These \tilde{z}ᵢⱼ partial terms are sent back to the client then.

4) Client Derives Cryptograph (FIG. 3/04)

Having received the set of \tilde{z}ᵢⱼ partial terms, the client reorders the set and extracts the relevant values for the zᵢⱼ terms. It then calculates the final cryptograph S as in (7).

C. Potential Attack is Minimum

Potential attack at this stage involves the guesswork for the rᵢⱼ values. Such attacks are extremely difficult to work out. If we choose k=11, we have 22 rᵢⱼ terms. Even each term has a value no larger than 63, the search space for the guesswork is already as large as 63²²≅10³⁹≅2¹²⁸, which would readily satisfy the security requirements of the nowadays Internet applications.

D. Efficiency Consideration

The computational burden for the client comes mostly from the calculation of (7). Eq. (7) requires modular exponentiations and multiplications. As commonly known, a batch of exponentiations can be carried out in a procedure of multiplications, and the number of multiplications is related to the bit length of the exponents and the number of exponentiations to be done in the batch.

By the above case of 22 exponentiations and each exponent is no larger than 63 (bit length is 6), the worst case would reckon roughly 132 modular multiplications and the average case is roughly 66.

In the comparison with the regular RSA, an exponentiation operation using a 1024-bit encoding key requires modular multiplications in the order of 2 times the encoding key length, i.e. 2048. Compared with that, the method by this embodiment presents a saving factor of 15 times or more to the client device on its CPU demand.

### EMBODIMENT 2

This method extends the first embodiment on the robustness of the client-server model. The former method does not anticipate sabotage attacks from the server side. The client takes the server calculations to the final cryptograph result by Eq. (7) without hesitation.

However, in the case that the server were compromised, the client might subject to attacks of malicious data manipulation. Hacker on the server might forge the zᵢⱼ values either by manipulating the \tilde{M}, {\tilde{e}ᵢⱼ} data sent to the server, or might fake the zᵢⱼ values altogether.

This method curbs sabotage attacks by taking the server calculation through 2 iterations and cross-verifying the results to discover any happenings of server-side forgery.

A. 2-iteration Model with Cross-Verification

Essentially, the method calculates M^{e} in 2 iterations of exponentiation. Forgery in any one of the iterations will get magnified in another. Without the knowledge of the client's secret parameters for those iterations, the attacker has no way to fake through the entire process.

The mathematical formulation is presented in the following. We decompose the exponent e (ref. (2)) with disparate parameters in 3 different formulations as follows.

$$\begin{matrix}\begin{matrix}e = {f}_{a} \cdot {g}_{a} + {h}_{a} \\ = ( {h}_{a} + ϵ ) \cdot {g}_{b} + {h}_{b} \\ = {f}_{a} \cdot {g}_{a} + ( {h}_{a} + ϵ ) \cdot {g}_{b} + {h}_{c}\end{matrix} & ( {2.1}^{′} ) \\ \begin{matrix}{M}^{e} = {( {M}^{{f}_{a}} )}^{{g}_{a}} \cdot {M}^{{h}_{a}} \\ = {( {M}^{{h}_{a}} \cdot {M}^{ϵ} )}^{{g}_{b}} \cdot {M}^{{h}_{b}} \\ = {( {M}^{{f}_{a}} )}^{{g}_{a}} \cdot {( {M}^{{h}_{a}} \cdot {M}^{ϵ} )}^{{g}_{b}} \cdot {M}^{{h}_{c}}\end{matrix} & ( {2.2}^{′} )\end{matrix}$$

And, the respective exponent terms, fₐ, gₐ, hₐ, g_{b}, h_{b}, h_{c}, are decomposed like it was done in (2).

fₐ=fₐ₁(rₐ₁₂−rₐ₁₁)+ . . . +fₐₖ(rₐₖ₂−rₐₖ₁)

gₐ=gₐ₁(sₐ₁₂−sₐ₁₁)+ . . . +gₐₖ(sₐₖ₂−sₐₖ₁)

g_{b}=g_{b1}(s_{b12}−s_{b11})+ . . . +g_{bk}(s_{bk2}−s_{bk1})

hₐ=hₐ₁(tₐ₁₂−tₐ₁₁)+ . . . +hₐₖ(tₐₖ₂−tₐₖ₁)

h_{b}=h_{b1}(t_{b12}−t_{b11})+ . . . +h_{bk}(t_{bk2}−t_{bk1})

h_{c}=h_{c1}(t_{c12}−t_{c11})+ . . . +h_{ck}(t_{ck2}−t_{ck1}) (2.3′)

We scramble M in the same way as in (3) with the mask a.

\tilde{M}=a·M mod n (3)

For the exponent terms, the random scrambling this time is done as follows. For i=1, . . . , k and j=1,2:

fₐᵢ₁=(fₐᵢ+uᵢ·rₐᵢ₁) fₐᵢ₂=−(fₐᵢ+uᵢ·rₐᵢ₂)

gₐᵢ₁=(gₐᵢ+vₐᵢ·sₐᵢ₁) gₐᵢ₂=−(gₐᵢ+vₐᵢ·sₐᵢ₂)

g_{bi1}=(g_{bi}+v_{bi}·s_{bi1}) g_{bi2}=−(g_{bi}+v_{bi}·s_{bi2})

hₐᵢ₁=(hₐᵢ+wₐᵢ·tₐᵢ₁) hₐᵢ₂=−(hₐᵢ+wₐᵢ·tₐᵢ₂)

h_{bi1}=(h_{bi}+w_{bi}·t_{bi1}) h_{bi2}=−(h_{bi}+w_{bi}·t_{bi2})

h_{ci1}=(h_{ci}+w_{ci}·t_{ci1}) h_{ci2}=−(h_{ci}+w_{ci}·t_{ci2}) (4′)

In the 1^{st} iteration, the zᵢⱼ terms are defined for the first-level exponentiation of (2.2′) with respect to the exponent terms fₐ, hₐ, h_{b} and h_{c}.

z_{faij}=\tilde{M}^{f}^{ₐᵢⱼ} mod n

zₕₐᵢⱼ=\tilde{M}^{h}^{ₐᵢⱼ} mod n

z_{hbij}=\tilde{M}^{h}^{_{bij}} mod n

z_{hcij}=\tilde{M}^{h}^{_{cij}} mod n (5′)

These zᵢⱼ terms from (5′) are combined to give the partial cryptographs, \dot{S}_{fa}, \dot{S}ₕₐ, \dot{S}_{hb}, \dot{S}_{hc}, as defined in below.

$${\dot{S}}_{fa} = {b}_{f} \cdot {\tilde{M}}^{{f}_{a}} \\ {\dot{S}}_{ha} = {b}_{h} \cdot {\tilde{M}}^{{h}_{a}} \cdot {\tilde{M}}^{ϵ} \\ {\dot{S}}_{hb} = {\tilde{M}}^{{h}_{b}} \\ {\dot{S}}_{hc} = {\tilde{M}}^{{h}_{c}} \\ \begin{matrix}where & {\tilde{M}}^{{f}_{a}} = ( {\prod }_{i = 1}^{k} ( {z}_{fai1}^{{r}_{ai2}} \cdot {z}_{fai2}^{{r}_{ai1}} ) ) mod n \\ & {\tilde{M}}^{{h}_{a}} = ( {\prod }_{i = 1}^{k} ( {z}_{hai1}^{{t}_{ai2}} \cdot {z}_{hai2}^{{t}_{ai1}} ) ) mod n \\ & {\tilde{M}}^{{h}_{b}} = ( {\prod }_{i = 1}^{k} ( {z}_{hbi1}^{{t}_{bi2}} \cdot {z}_{hbi2}^{{t}_{bi1}} ) ) mod n \\ & {\tilde{M}}^{{h}_{c}} = ( {\prod }_{i = 1}^{k} ( {z}_{hci1}^{{t}_{ci2}} \cdot {z}_{hci2}^{{t}_{ci1}} ) ) mod n\end{matrix} \qquad ( {7}^{′} )$$

Now in the 2^{nd} iteration, the partial cryptographs are fed through the exponentiation process for one more time to complete (2.2′) with the second-level exponentiation. We define another set of partial terms, \dot{z}_{fij},\dot{z}ₕᵢⱼ, for this iteration.

\dot{z}_{fij}=\dot{S}_{fa} ^{g}^{_{ay}} mod n

\dot{z}ₕᵢⱼ=\dot{S}ₕₐ ^{g}^{_{by}} mod n (8′)

Similar to (7′), the partial terms are combined to give the partial cryptographs.

$${\ddot{S}}_{1} = {( {\dot{S}}_{fa} )}^{{g}_{a}} = ( {B}_{f} \cdot {\prod }_{i = 1}^{k} ( {\dot{z}}_{fi1}^{{s}_{ai2}} \cdot {\dot{z}}_{fi2}^{{s}_{ai1}} ) ) mod n \\ {\ddot{S}}_{2} = {( {\dot{S}}_{ha} )}^{{g}_{b}} = ( {B}_{h} \cdot {\prod }_{i = 1}^{k} ( {\dot{z}}_{hi1}^{{s}_{bi2}} \cdot {\dot{z}}_{hi2}^{{s}_{bi1}} ) ) mod n \\ \begin{matrix}where & {b}_{f}^{{g}_{a}} \cdot {B}_{f} ≡ 1 ( mod n ) \\ & {b}_{h}^{{g}_{b}} \cdot {B}_{h} ≡ 1 ( mod n )\end{matrix} \qquad ( {9}^{′} )$$

The final cryptograph S now can be derived with the partial cryptographs from (9′). From the formulation of (2.2′), three versions of S can be calculated.

S₁=A·\ddot{S}₁·\dot{S}ₕₐ=(M^{f}^{ₐ})^{g}^{ₐ}·M^{h}^{ₐ} mod n

S₂=A·\ddot{S}₂·\dot{S}_{hb}=(M^{h}^{ₐ}·M^{ε})^{g}^{_{b}}·M^{h}^{_{b}} mod n

S₃=A·\ddot{S}₁·\ddot{S}₂·\dot{S}_{hc}=(M^{f}^{ₐ})^{g}^{ₐ}·(M^{h}^{ₐ}·M^{ε})^{g}^{_{b}}·M^{h}^{_{c}} mod n (10′)

The rationale for 3 different formulations for S is to build the mechanism in the process for cross-verification on the calculation of S. Agreement of the 3 versions indicates the validity of the server-side calculations. Hence, if S₁=S₂=S₃ in (10′), the calculations are considered to be correct, and any one of the three can be reported with confidence for the final cryptograph S.

B. The Client-Server Protocol

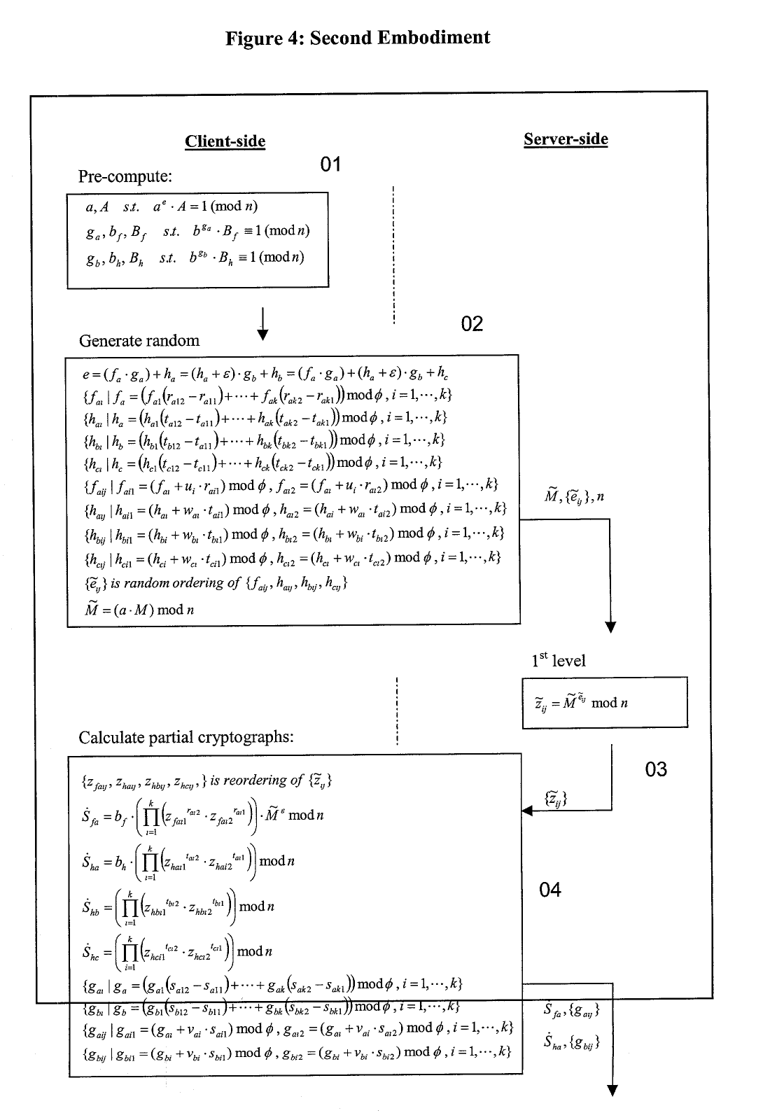

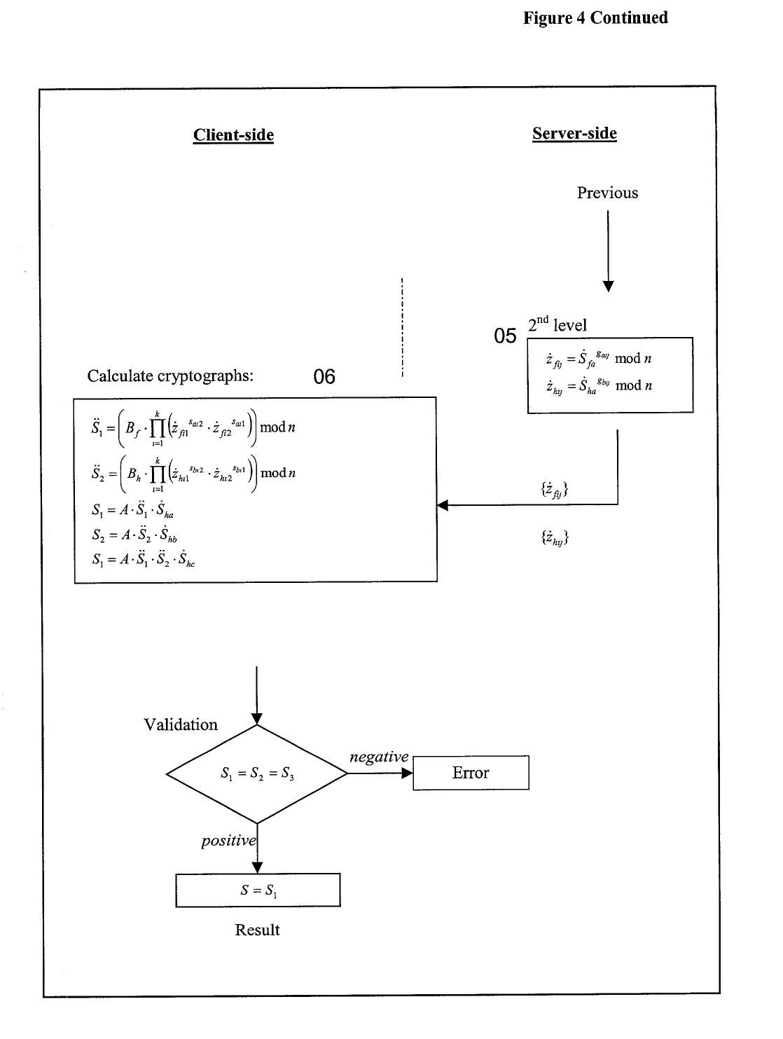

1 Pre-processing (FIG. 4/01)

Like it in the Embodiment 1, the random number a, and its reciprocal A, are generated as the parameters for scrambling the message code in (3), and for de-scrambling for the final cryptograph in (10′).

In addition, two sets of random numbers, (gₐ, b_{f}, B_{f}) and (g_{b}, bₕ, Bₕ), are generated and stored in this pre-processing stage. The values gₐ and g_{b} are to be used in (2.1′) whereas (b_{f}, B_{f}) and (bₕ, Bₕ) are the reciprocal pairs used in (7′) and (9′).

2) Client Generates Random Numbers (FIG. 4/02)

During runtime, the client generates the random decomposition of the crypto key e into the set of fₐᵢⱼ, hₐᵢⱼ, h_{bij} and h_{cij} terms (ref (2′) and (4′)). Note that the ε in (2′) as well as the rₐᵢⱼ, sₐᵢⱼ, s_{bij}, tₐᵢⱼ, t_{bij} and t_{cij} terms in (4′) are all small integers such that the exponentiations with them by the client in the subsequent steps 4 and 6 are manageable.

The client scrambles M with a as in (3) to give \tilde{M}. The fₐᵢⱼ, hₐᵢⱼ, h_{cij} and h_{cij} terms are all mixed in one single pool and randomized in their ordering. Let the randomized sequence be referred as {\tilde{e}ᵢⱼ}.

The scrambled \tilde{M} and the randomized exponents {\tilde{e}ᵢⱼ} are sent to the server for computing the exponentiations.

3) Server Computes Exponentiations (FIG. 4/03)

Upon receiving the scrambled data, \tilde{M} and {\tilde{e}ᵢⱼ}, from the client, the server calculates the exponentiation terms \tilde{z}ᵢⱼ=\tilde{M}^{\tilde{e}}^{ᵢⱼ}.

4) Client Calculates Partial Cryptographs (FIG. 4/04)

When the \tilde{z}ᵢⱼ partial terms are returned from the server side, the client undoes the random ordering of the set {\tilde{z}ᵢⱼ} to obtain the values for the respective terms of z_{faij}, zₕₐᵢⱼ, z_{hbij}, and z_{hcij}.

The client then calculates \dot{S}_{fa}, \dot{S}ₕₐ, \dot{S}_{hb}, \dot{S}_{hc} as in (7′).

The client also calculates the decomposition of gₐ and g_{b} for the sets of {gₐᵢⱼ} and {g_{bij}} (ref. (2′) and (4′)). Data of (\dot{S}_{fa}, {gₐᵢⱼ}) and (\dot{S}ₕₐ, {g_{bij}}) are sent to the server for the 2^{nd} iteration of exponentiation.

5) Server Computes Exponentiation of 2^{nd} Iteration (FIG. 4/05)

The server computes the \dot{z}_{fij} values in (8′) when \dot{S}_{fa}, {gₐᵢⱼ} are received. By the same logic, it computes \dot{z}ₕᵢⱼ on the received data \dot{S}ₕₐ, {g_{bij}}.

The results are then returned to the client side.

6) Client Derives and Verifies Final Cryptograph (FIG. 4/06)

The client derives the cryptograph in (9′) and (10′).

Three versions S₁, S₂ and S₃ are calculated. At this point, the client verifies the validity of these cryptographs against possible attacks from the server side by testing whether S₁, S₂ and S₃ all agree with each other. Testing positive, the client reports any one of the three as the final cryptograph S=M^{e}.

C. Verification Test is Effective

The verification test by the 2-iteration scheme is strong and tight in the sense that any malicious manipulation and forgery will be detected and prevented thereby.

Consider how the server-side attack could sabotage the overall calculation for S=M^{e}. Hacker breaking in the server could intercept the exponentiation processes as laid out in (5′) and (8′). These calculations are in the form of Z=X^{Y}. Hence, the hacker could launch any of the following 3 attacks:

1. Manipulating X

2. Manipulating Y

3. Forging Z

1^{st} Form of Attack—Manipulating X.

The hacker could manipulate the \tilde{M} value in (5′), and thus faked the values for \tilde{M}^{f}^{ₐ}, \tilde{M}^{h}^{ₐ}, \tilde{M}^{h}^{_{b}}, \tilde{M}^{h}^{_{c}} in (10′). Note that the calculation of \tilde{M}^{ε} is kept to the client side, and thus is safe from attacks. As the hacker has no way to estimate the impact of \tilde{M}^{ε} in the equation system (10′), he cannot manipulate \tilde{M} in such a way that the effect is coherent across S₁, S₂ and S₃. Hence, such attack is difficult.

2^{nd} Form of Attack—Manipulating Y.

The hacker could manipulate the exponents fₐ, hₐ, h_{b}, h_{c} and gₐ, g_{b} by forging their values in the calculations of (5′) and (8′). However, any manipulation on fₐ and hₐ will get magnified by the factors of gₐ and g_{b} in the 2^{nd} iteration, which are unknown to the hacker throughout the process. Therefore, the hacker indeed has no way to control his sabotage on S₁, S₂ and S₃ in (10′) in a coordinated fashion so as to fake it through the entire verification test.

3^{rd} Form of Attack—Forging Z.

In this case, the hacker could return a forged value for the z term as if it were calculated from (5′) to sabotage the calculation of (10′). However, it is practically impossible to do so because any forgery on the z values sabotaging S₁ will be routed through \dot{S}_{fa} and \dot{S}ₕₐ before landing on (10′). The hacker would have no way to predict and control the impact of \dot{S}_{fa} and \dot{S}ₕₐ during the 2^{nd} iteration due to his null knowledge of gₐ and g_{b}.

Moreover, neither could the hacker return a forged value for z as if it were from (8′). Imagine that the hacker faked some z values in (8′) to give \ddot{S}₁ and \dot{S}₂ that were seemingly good for the test of (10′). Since 2 alterations (\ddot{S}₁ and \ddot{S}₂) cannot satisfy a 3-way agreement (among S₁, S₂ and S₃) at the same time, the attack is essentially not possible.

D. Other Attack Consideration

Hacker trying to crack the private key e (2.1′) would have to involve himself in the guesswork for the private data in the client's calculations of (7′) and (9′). Take the first formulation of (2.1′) for example, the hacker with the z values known to him from (5′) and (8′) would have to match the z values to the formulas in (7′) and (9′) and guess out the values for the rₐᵢⱼ, sₐᵢⱼ and tₐᵢⱼ terms for the calculation.

If we choose k=4, we will have 8 fₐᵢⱼ, 8 gₐᵢⱼ and etc. in (4′). That will give 32 z values in (5′). Suppose the rₐᵢⱼ, sₐᵢⱼ and tₐᵢⱼ terms all have values ranging from 1 to 15. Matching up the z values to the formulas in (7′) and guessing the rₐᵢⱼ, sₐᵢⱼ and tₐᵢⱼ values for calculation of the formulas would cost

i) C(32,8)·15⁸ searches for the calculation related to rₐᵢⱼ's in (7′)

ii) C(24,8)·15⁸ searches related to tₐᵢⱼ's in (7′)

iii) 15⁸ searches related to sₐᵢⱼ's in (9′).

Altogether the hacker will be running up against a search space of

C(32,8)·15⁸·C(24,8)·15⁸·15⁸≅10⁴¹≅2¹²⁸

Security strength by such search space is satisfactory.

E. Efficiency Consideration

The computational burden for the client this time is primarily due to (7′) and (9′). There are 6 formulas of exponentiation to be evaluated. By the same analysis we did in the previous embodiment, the number of exponentiations to be carried out in (7′) and (9′) together is 48. As the exponents are 4-bit numbers, the worst case would reckon roughly 192 modular multiplications and the average case is roughly 96.

Compared with the 2048 multiplications in the regular 1024-bit RSA, this method gives the client device a saving factor of 10 or more on the CPU demand.

A number of references have been cited, the entire disclosures of which are incorporated herein by reference.

What is claimed is:

1. A communication system for communicating securely encrypted messages, comprising:
i. a resource-constrained client;
ii. a gateway server possessing high computational power capable of doing fast and dynamic encryption-related computations when requested by the client and returning the result to the client;
iii. an application server communicating encrypted messages with the client; and
iv. a communication network connecting the client, the gateway server, and the application server.

2. The communication system as in claim 1, wherein the communication network is a wireless communication network.

3. The communication system as in claim 2, wherein the gateway server is a wireless gateway server.

4. The communication system as in claim 2, wherein the client is a mobile device.

5. The communication system as in claim 1, wherein the encrypted messages are encoded using public-key cryptography.

6. The communication system as in claim 5, wherein the public-key cryptography is achieved using RSA algorithm.

7. The communication system as in claim 1, wherein the client further comprises means for storing and generating the encryption key, generating random numbers and doing modular multiplication.

8. The communication system as in claim 7, wherein the random numbers are generated for scrambling the encryption key and the original message as well as decomposing the encryption key.

9. The communication system as in claim 8, wherein the scrambled and decomposed encryption key and the scrambled original message are sent from the client to the gateway server.

10. The communication system as in claim 7, wherein the modular multiplication is performed based on the result returned by the gateway server.

11. The communication system as in claim 1, wherein the encryption-related computations performed by the gateway server are integer exponentiation.

12. A method for encrypting a message using a client-server model, comprising the steps of:
i. the client generates random numbers;
ii. the client uses the random numbers to scramble both the encryption key and the original message as well as decompose the encryption key;
iii. the client sends the scrambled and decomposed encryption key and the scrambled message to the server;
iv. the server computes the exponentiation of the scrambled message being raised to the power of each decomposed scrambled encryption key;
v. the server sends the computation results to the client; and
vi. the client extracts the encryption result using a modular multiplication of the results returned by the sever.

13. The method as in claim 12, wherein the client is a mobile device.

14. The method as in claim 12, wherein the server is a wireless gateway server.

15. A two-iteration client-server encryption method for protecting encrypted messages from attacks made by un-trusted server, comprising the steps of:
i. the client generates multiple sets of random numbers;
ii. the client uses each set of random numbers to scramble both the encryption key and the original message as well as decompose the encryption key;
iii. the client sends each set of scrambled and decomposed encryption key and the scrambled message to the server;
iv. the server computes the exponentiation of each set of the scrambled message being raised to the power of each decomposed scrambled encryption key in the same set;
v. the server sends the computation results to the client;
vi. the client extracts the encrypted message for each set using a modular multiplication of the results returned by the sever;
vii. the client feeds the encrypted messages once more to the server and the server performs the exponentiation one more time; and
viii. the client derives the encrypted messages one more time and verifies if each set returns the same encrypted message.

16. The method as in claim 15, wherein the number of sets of random numbers is three.

17. The method as in claim 15, wherein the client is a mobile device.

18. The method as in claim 15, wherein the server is a wireless gateway server.
